(19) United States
(12) Patent Application Publication
(10) Pub. No.: US 2024/0291751 A1
(43) Pub. Date: Aug. 29, 2024

(54) DEVICE AND METHOD FOR PROCESSING DATA UNITS

(71) Applicant: Robert Bosch GmbH, Stuttgart (DE)

(72) Inventors: Filip Moerman, Tourrettes sur Loup (FR); Herbert Leuwer, LANGBALLIG (DE); Mourad Ahdjoudj, ANTIBES (FR); Thomas Wollenhaupt, Backnang (DE)

(21) Appl. No.: 18/568,652

(22) PCT Filed: Jun. 13, 2022
(86) PCT No.: PCT/EP2022/065994

§ 371 Date: Dec. 8, 2023

(30) Foreign Application Priority Data
Jun. 18, 2021 (DE) 10 2021 206 267.9

(51) Int. Cl. H04L 45/302; H04L 45/00

(52) U.S. Cl. CPC H04L 45/304; H04L 45/54

(57) ABSTRACT

A device for processing data units, for example protocol data units. The device has a first number of input interfaces for receiving protocol data units and a second number of output interfaces for outputting protocol data units, and a processing apparatus, which is configured to perform, based on a PDU identifier associated with a received protocol data unit, a search in at least a first search tree, which has an allocation of in each case one PDU identifier to a connection identifier characterizing at least one data connection.

### FIELD

The present invention relates to a device for processing data units.

The present invention further relates to a method for processing data units.

### SUMMARY

Exemplary embodiments of the present invention relate to a device for processing data units, for example protocol data units, having a first number of input interfaces for receiving protocol data units and a second number of output interfaces for outputting protocol data units, and a processing apparatus, which is designed to perform, based on a PDU identifier associated with a received protocol data unit, a search in at least a first search tree, which has an allocation of in each case one PDU identifier to a connection identifier characterizing at least one data connection.

In further exemplary embodiments of the present invention, the first number is greater than or equal to one. In further exemplary embodiments, the second number is greater than or equal to one.

In further exemplary embodiments of the present invention, it is provided that the device is designed to ascertain, based on the received protocol data unit, a connection identifier associated with the received protocol data unit.

In further exemplary embodiments of the present invention, it is provided that the processing apparatus has at least one hardware component, which is designed to perform the search in the first search tree and/or to ascertain the connection identifier associated with the received protocol data unit.

In further exemplary embodiments of the present invention, it is provided that the first search tree is a binary tree.

In further exemplary embodiments of the present invention, it is provided that the search tree is a ternary or n-nary, n>3, tree.

In further exemplary embodiments of the present invention, it is provided that the device is designed to output, based on the connection identifier associated with the received protocol data unit, the received protocol data unit to at least one particular output interface of the second number of output interfaces.

In further exemplary embodiments of the present invention, it is provided that the processing apparatus has at least one software component, which is designed to at least temporarily a) form and/or b) modify, for example balance, the first search tree.

In further exemplary embodiments of the present invention, it is provided that the at least one software component is designed to perform a predeterminable response if no connection identifier associated with the received protocol data unit can be ascertained for the received protocol data unit, for example if no connection identifier associated with the received protocol data unit is present for the received protocol data unit in the first search tree, wherein, for example, the predeterminable response has at least one of the following elements: a) discarding the received protocol data unit, b) assigning a connection identifier, for example a configurable connection identifier, to the received protocol data unit, c) setting or inserting a first piece of information for the received protocol data unit, for example in the form of a bit flag, wherein the first piece of information indicates, for example, that the received protocol data unit is to be subjected to a check, for example by means of a firewall apparatus.

In further exemplary embodiments of the present invention, it is provided that the device, for example the at least one software component, is designed to generate, for example based on the first search tree, a second search tree and/or to manage it, for example to modify it.

In further exemplary embodiments of the present invention, it is provided that the first search tree and/or the second search tree is a red-black tree.

In further exemplary embodiments of the present invention, it is provided that the first search tree is a binary tree, for example without color information (for example, red/black), and that the second search tree is a red-black tree. This enables an efficient, for example hardware-based, search, for example by means of the at least one hardware component, in the first search tree, wherein, for example, no color information is available for the search, whereas, for efficient management of the second search tree, the second search tree is designed as a red-black tree.

In further exemplary embodiments of the present invention, it is provided that the device is designed to organize the first search tree and/or the second search tree at least temporarily in the form of at least one table.

In further exemplary embodiments of the present invention, it is provided that the device is designed to, in a manner at least partially overlapping in time, a) ascertain, based on the received protocol data unit, a connection identifier associated with the received protocol data unit, for example by means of the at least one hardware component, for example by means of performing the search in the first search tree by the at least one hardware component, and b) generate, for example by means of the at least one software component, a or the second search tree, for example based on the first search tree, and/or to manage it, for example to modify it.

In further exemplary embodiments of the present invention, it is provided that the device is designed to perform at least one of the following elements: a) using the first search tree or the second search tree at least temporarily, for example selectively, for example to ascertain the connection identifier associated with the received protocol data unit, b) transmitting a content and/or a structure of the second search tree to the first search tree, c) transmitting a content and/or a structure of the first search tree to the second search tree.

In further exemplary embodiments of the present invention, it is provided that the device, for example the at least one software component, is designed to signal, for example to the at least one hardware component, at least one of the following elements, for example by means of a second piece of information: a) the first search tree is to be used for performing the search, b) the second search tree is to be used for performing the search, c) a modification of the first search tree and/or of the second search tree, for example an insertion of at least one node and/or a balancing of the tree concerned, has been completed.

In further exemplary embodiments of the present invention, it is provided that the device, for example the at least one hardware component, is designed to use, based on the signaling, the first search tree or the second search tree for performing the search.

In further exemplary embodiments of the present invention, it is provided that the device, for example the at least one hardware component, is designed to activate the first search tree or the second search tree for performing the search between two, for example successive, searches, for example for the future performance of the search or searches, for example by specifying which of the two search trees is to be used from then on for performing the search or searches.

In further exemplary embodiments of the present invention, it is provided that the device is designed to control or regulate a rate at which protocol data units are output via at least one output interface of the second number of output interfaces.

In further exemplary embodiments of the present invention, it is provided that the device has at least one memory for at least temporarily storing one or more protocol data units or parts of one or more protocol data units.

In further exemplary embodiments of the present invention, it is provided that the device has a conditioning apparatus, which is designed to change, for example normalize, a PDU identifier associated with a received protocol data unit.

Further exemplary embodiments of the present invention relate to a method, for example a computer-implemented method, for processing data units, for example protocol data units, for a device, for example according to at least one of the above-described embodiments, having a first number of input interfaces for receiving protocol data units and a second number of output interfaces for outputting protocol data units, and a processing apparatus, wherein the method comprises: performing, based on a PDU identifier associated with a received protocol data unit, a search in at least a first search tree, which has an allocation of in each case one PDU identifier to a connection identifier characterizing at least one data connection.

In further exemplary embodiments of the present invention, it is provided that the method comprises: ascertaining, based on the received protocol data unit, a connection identifier associated with the received protocol data unit.

In further exemplary embodiments of the present invention, it is provided that the processing apparatus has at least one hardware component, wherein performing the search in the first search tree and/or ascertaining the connection identifier associated with the received protocol data unit is performed by means of the at least one hardware component.

In further exemplary embodiments of the present invention, it is provided that the processing apparatus has at least one software component, wherein the method comprises: a) at least temporarily forming the search tree by means of the at least one software component, and/or b) at least temporarily modifying, for example balancing, the search tree by means of the at least one software component.

Further exemplary embodiments of the present invention relate to a device for performing the method according to the embodiments of the present invention.

Further exemplary embodiments of the present invention relate to a computer-readable storage medium comprising instructions that, when executed by a computer, cause the computer to perform at least some steps of the method according to the embodiments of the present invention.

Further exemplary embodiments of the present invention relate to a computer program comprising instructions that, when the program is executed by a computer, cause the computer to perform at least some steps of the method according to the embodiments of the present invention.

Further exemplary embodiments of the present invention relate to a data carrier signal that transmits and/or characterizes the computer program according to the embodiments of the present invention.

Further exemplary embodiments of the present invention relate to a gateway, for example an automotive gateway, comprising at least one device according to the embodiments of the present invention.

Further exemplary embodiments of the present invention relate to a use of the device according to the embodiments of the present invention and/or of the method according to the embodiments of the present invention and/or of the computer-readable storage medium according to the embodiments of the present invention and/or of the computer program according to the embodiments of the present invention and/or of the data carrier signal according to the embodiments of the present invention and/or of the gateway according to the embodiments of the present invention for at least one of the following elements: a) processing data units, for example protocol data units, for example of a vehicle, for example a motor vehicle, b) ascertaining, for example searching for, for example by means of a hardware component, a connection identifier associated with a received protocol data unit, c) managing at least one search tree, d) performing a hardware-based search of a connection identifier for a data unit, for example a protocol data unit, for example of a gateway for automotive applications, wherein, for example, the search can be performed with logarithmic effort, e) routing or forwarding data units, for example protocol data units, for example of a vehicle, for example a motor vehicle, wherein, for example, the data units can be of different types, f) assigning a connection identifier, for example a connection identifier independent of the protocol, g) performing multicast transmissions, h) ascertaining whether no connection identifier is provided, for example stored, for example contained in the search tree, for a predeterminable received data unit, for example a protocol data unit, i) software-based processing of a received data unit, for example a protocol data unit, for which no connection identifier is provided, for example stored, for example contained in the search tree.

Further features, possible applications and advantages of the present invention will be apparent from the following description of exemplary embodiments of the present invention shown in the figures. In this case, all of the features described or shown form the subject matter of the present invention individually or in any combination, irrespective of their wording or representation in the description herein or in the figures.

### BRIEF DESCRIPTION OF THE DRAWINGS

FIG. 1 schematically shows a simplified block diagram according to exemplary embodiments of the present invention.

FIG. 2 schematically shows a simplified block diagram according to exemplary embodiments of the present invention.

FIG. 3 schematically shows a simplified flow diagram according to exemplary embodiments of the present invention.

FIG. 4 schematically shows a simplified flow diagram according to exemplary embodiments of the present invention.

FIG. 5 schematically shows a simplified flow diagram according to exemplary embodiments of the present invention.

FIG. 6 schematically shows a simplified flow diagram according to exemplary embodiments of the present invention.

FIG. 7 schematically shows a simplified flow diagram according to exemplary embodiments of the present invention.

FIG. 8 schematically shows a simplified flow diagram according to exemplary embodiments of the present invention.

FIG. 9 schematically shows a simplified flow diagram according to exemplary embodiments of the present invention.

FIG. 10 schematically shows a simplified flow diagram according to exemplary embodiments of the present invention.

FIG. 11 schematically shows a simplified flow diagram according to exemplary embodiments of the present invention.

FIG. 12 schematically shows a simplified block diagram according to exemplary embodiments of the present invention.

FIG. 13 schematically shows a simplified block diagram according to exemplary embodiments of the present invention.

FIG. 14 schematically shows a simplified flow diagram according to exemplary embodiments of the present invention.

FIG. 15 schematically shows a simplified block diagram according to exemplary embodiments of the present invention.

FIG. 16 schematically shows a simplified block diagram according to exemplary embodiments of the present invention.

FIG. 17 schematically shows aspects of uses according to exemplary embodiments of the present invention.

### DETAILED DESCRIPTION OF EXAMPLE EMBODIMENTS

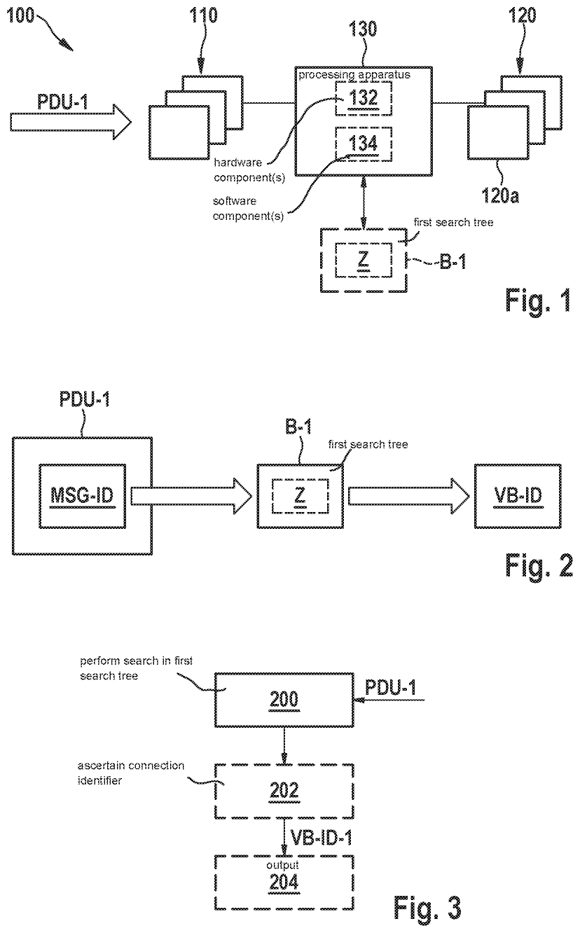

Exemplary embodiments of the present invention, see FIG. 1, relate to a device 100 for processing data units PDU-1, for example protocol data units, having a first number of input interfaces 110 for receiving protocol data units PDU-1 and a second number of output interfaces 120, 120a for outputting protocol data units, and a processing apparatus 130, which is designed to perform, based on a PDU identifier MSG-ID associated with a received protocol data unit PDU-1, see FIG. 2, a search in at least a first search tree B-1 (FIG. 1), which has an allocation Z of in each case one PDU identifier MSG-ID (FIG. 2) to a connection identifier VB-ID characterizing at least one data connection.

A flow diagram of a corresponding method according to exemplary embodiments is shown in FIG. 3, wherein block 200 symbolizes the performance of the search in the at least one first search tree B-1 (FIG. 1).

In further exemplary embodiments, it is provided that the device 100 (FIG. 1) is designed to ascertain, based on the received protocol data unit PDU-1, a connection identifier VB-ID-1 associated with the received protocol data unit PDU-1, see the optional block 202 according to FIG. 3, for example by means of the search 200 in the first search tree B-1.

In further exemplary embodiments, it is provided that the processing apparatus 130 (FIG. 1) has at least one hardware component 132, which is designed to perform the search 200 in the first search tree B-1 and/or to ascertain 202 the connection identifier VB-ID-1 associated with the received protocol data unit PDU-1.

In further exemplary embodiments, it is provided that the first search tree B-1 is a binary tree.

In further exemplary embodiments, it is provided that the first search tree B-1 is a ternary or n-nary, n>3, tree.

In further exemplary embodiments, it is provided that the device is designed to output, based on the connection identifier VB-ID-1 associated with the received protocol data unit PDU-1, the received protocol data unit PDU-1 and/or data derivable or derived therefrom to at least one particular output interface 120a (FIG. 1) of the second number of output interfaces 120, see the optional block 204 according to FIG. 3.

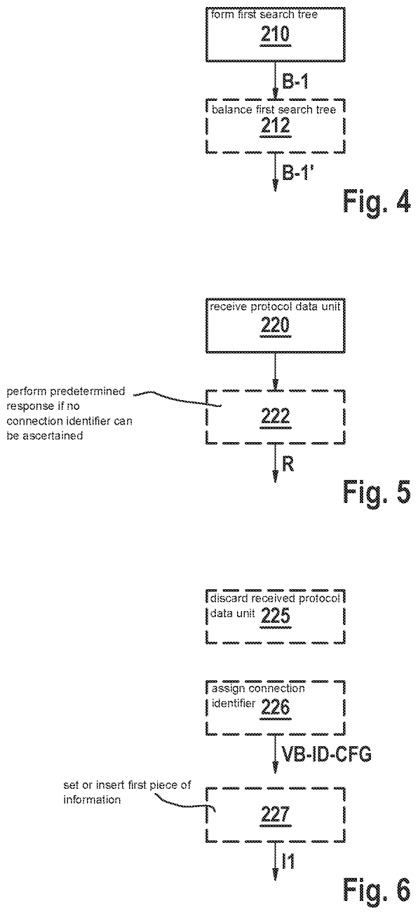

In further exemplary embodiments, FIG. 1, it is provided that the processing apparatus 130 has at least one software component 134, which is designed to at least temporarily a) form the first search tree B-1, see block 210 according to FIG. 4, and/or b) modify it, for example to balance it, see block 212. In further exemplary embodiments, a modified, for example balanced, first search tree B-1 can be obtained based on the modification 212.

In further exemplary embodiments, FIGS. 5, 6, it is provided that the at least one software component 134 (FIG. 1) is designed to perform 222 a predeterminable response R if no connection identifier VB-ID-1 associated with the received protocol data unit PDU-1 can be ascertained for the received protocol data unit PDU-1, for example if no connection identifier VB-ID-1 associated with the received protocol data unit PDU-1 is present for the received protocol data unit PDU-1 in the first search tree B-1, wherein, for example, the predeterminable response R has at least one of the following elements: a) discarding 225 the received protocol data unit PDU-1, b) assigning 226 a connection identifier VB-ID-CFG, for example a configurable connection identifier, to the received protocol data unit PDU-1, c) setting or inserting 227 a first piece of information I1 for the received protocol data unit PDU-1, for example in the form of a bit flag, wherein the first piece of information I1 indicates, for example, that the received protocol data unit PDU-1 is to be subjected to a check, for example by means of a firewall apparatus. In further exemplary embodiments, block 220 according to FIG. 5 symbolizes a reception of the protocol data unit PDU-1.

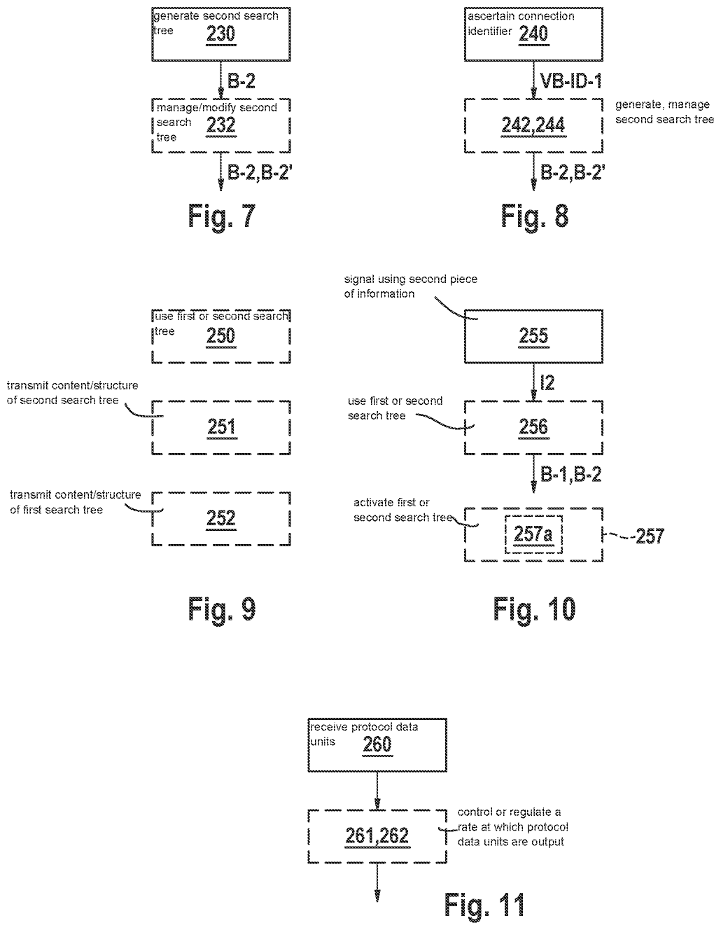

In further exemplary embodiments, FIG. 7, it is provided that the device 100 (FIG. 1), for example the at least one software component 134, is designed to generate 230, for example based on the first search tree B-1, a second search tree B-2 and/or to manage 232 it, for example to modify it, wherein, for example, a modified second search tree B-2′ can be obtained.

In further exemplary embodiments, it is provided that the first search tree B-1 and/or the second search tree B-2 is a red-black tree.

In further exemplary embodiments, it is provided that the first search tree B-1 is a binary tree, for example without color information (for example, red/black), and that the second search tree B-2 is a red-black tree. This enables an efficient, for example hardware-based, search, for example by means of the at least one hardware component 132, in the first search tree B-1, wherein, for example, no color information is available for the search, whereas, in further exemplary embodiments, for example for efficient management of the second search tree B-2, the second search tree B-2 is designed as a red-black tree.

In further exemplary embodiments, it is provided that the device 100 is designed to organize the first search tree B-1 and/or the second search tree B-2 at least temporarily in the form of at least one table.

In further exemplary embodiments, FIG. 8, it is provided that the device 100 is designed to, in a manner at least partially overlapping in time, a) ascertain 240, based on the received protocol data unit PDU-1, a connection identifier VB-ID-1 associated with the received protocol data unit PDU-1, for example by means of the at least one hardware component 132, for example by means of performing the search in the first search tree B-1 by the at least one hardware component 132, and b) generate 242, for example by means of the at least one software component 134, a or the second search tree B-2, for example based on the first search tree B-1 (for example by copying the first search tree B-1), and/or to manage 244 it, for example to modify it (for example transforming it into a red-black tree and/or changing the elements or structure of the search tree).

In further exemplary embodiments, FIG. 9, it is provided that the device 100 is designed to perform at least one of the following elements: a) using 250 the first search tree B-1 or the second search tree B-2 at least temporarily, for example selectively, for example to ascertain the connection identifier VB-ID-1 associated with the received protocol data unit PDU-1, b) transmitting 251 a content and/or a structure of the second search tree B-2 to the first search tree B-1 (for example, in order to make a search tree B-2, B-2′ that is modified, for example balanced, for example by means of the software component 134, in relation to the first search tree B-1, which can be searched, for example by means of the hardware component 132), c) transmitting 252 a content and/or a structure of the first search tree B-1 to the second search tree B-2 (for example, in order to prepare a modification that can be performed, for example, by means of the software component 134).

In further exemplary embodiments, FIG. 10, it is provided that the device, for example the at least one software component, is designed to signal 255, for example to the at least one hardware component, at least one of the following elements, for example by means of a second piece of information 12: a) the first search tree B-1 is to be used for performing the search, b) the second search tree B-2 is to be used for performing the search, c) a modification of the first search tree B-1 and/or of the second search tree B-2, for example an insertion of at least one node and/or a balancing of the search tree concerned, has been completed.

In further exemplary embodiments, it is provided that the device 100, for example the at least one hardware component 132, is designed to use 256, based on the signaling 255, the first search tree B-1 or the second search tree B-2 for performing the search.

In further exemplary embodiments, it is provided that the device 100, for example the at least one hardware component 132, is designed to activate 257 the first search tree B-1 or the second search tree B-2 for performing the search between two, for example successive, searches, for example for performing the search or searches, for example by specifying 257a which of the two search trees is to be used from then on for performing the search or searches.

In further exemplary embodiments, FIG. 11, it is provided that the device 100 is designed to control 261 or regulate 262 a rate at which protocol data units are output via at least one output interface of the second number of output interfaces. For example, block 260 in FIG. 11 symbolizes a reception of protocol data units for which the mentioned rate is controlled 261 or regulated 262 in further exemplary embodiments.

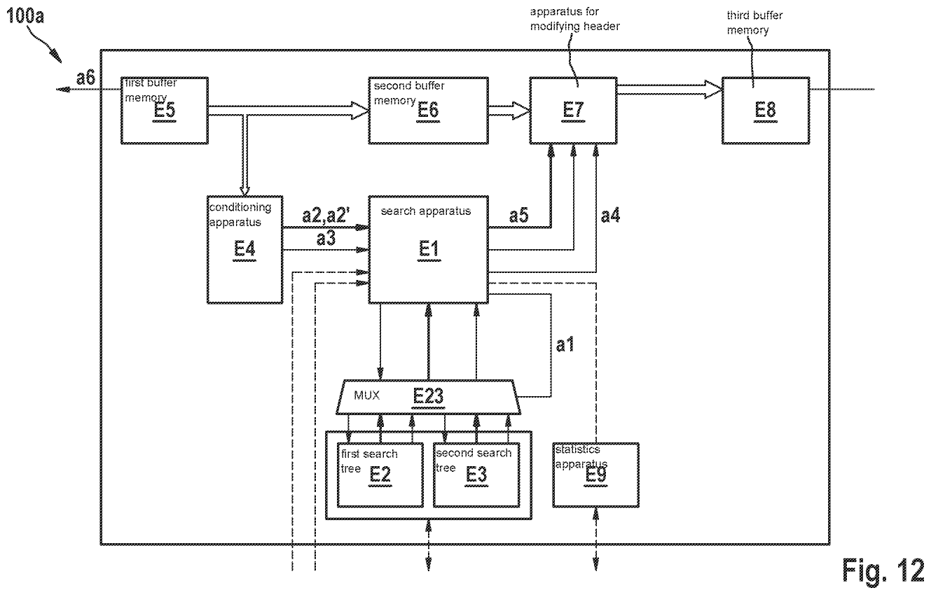

FIG. 12 schematically shows a simplified block diagram of a device 100a according to exemplary embodiments, which in further exemplary embodiments can have a functionality comparable to the device 100 according to FIG. 1.

Block E1 according to FIG. 12 symbolizes a search apparatus, for example a search apparatus implementable in the form of hardware, for example by means of or comparable to the hardware component 132 according to FIG. 1.

Block E2 symbolizes the first search tree B-1 (FIG. 1), for example a search tree that can be organized in the form of a first table, which in further exemplary embodiments can be referred to as, for example, a “work table.” Block E3 symbolizes the second search tree B-2 (FIG. 7), for example a search tree that can be organized in the form of a second table, which in further exemplary embodiments can be referred to as, for example, a “shadow table.”

In further exemplary embodiments, the device 100a has a multiplexer apparatus E23, via which the search apparatus E1 can, for example, selectively access the first table E2 or the second table E3, for example in order to perform a search, see block 200 according to FIG. 3. In further exemplary embodiments, selection of the first table E2 or of the second table E3 can be realized, for example, by means of a control signal a1, which in further exemplary embodiments can, for example, form the search apparatus E1 and/or output it to the multiplexer apparatus E23.

In further exemplary embodiments, it is provided that the device 100a has at least one memory for at least temporarily storing one or more, for example received, protocol data units PDU-1 (FIG. 1) or parts of one or more protocol data units. The device 100a has, for example, a first buffer memory E5, which can, for example, at least temporarily store incoming protocol data units or protocol data units that can be received or are received by the device 100a, for example according to the FIFO (first in first out) principle. Optionally, the first buffer memory E5 can also perform a desegmentation of received protocol data units, at least temporarily.

In further exemplary embodiments, the device 100a has a second buffer memory E6, which can be used, for example, for “delaying” at least one received protocol data unit, i.e., for example, for temporarily buffering the received protocol data unit or at least part of the received protocol data unit, for example until the protocol data unit is output, for example at a possibly predeterminable later point in time.

In further exemplary embodiments, the second buffer memory E6 is designed to delay a received protocol data unit until the search apparatus E1 has ascertained the connection identifier VB-ID-1 associated with the received protocol data unit PDU-1, for example by a search performed in the first search tree B-1, E2, for example by means of the hardware component 132, E1.

In further exemplary embodiments, a storage capacity or storage size of the second buffer memory E6 can be predetermined based on a maximum search duration in the first search tree B-1. For example, when using a binary first search tree B-1 in further exemplary embodiments, it can be assumed that a maximum search duration is proportional to a logarithm, for example a logarithm dualis (ld), of a number of nodes of the search tree and to a number of clock cycles required for reading and evaluating a node of the search tree.

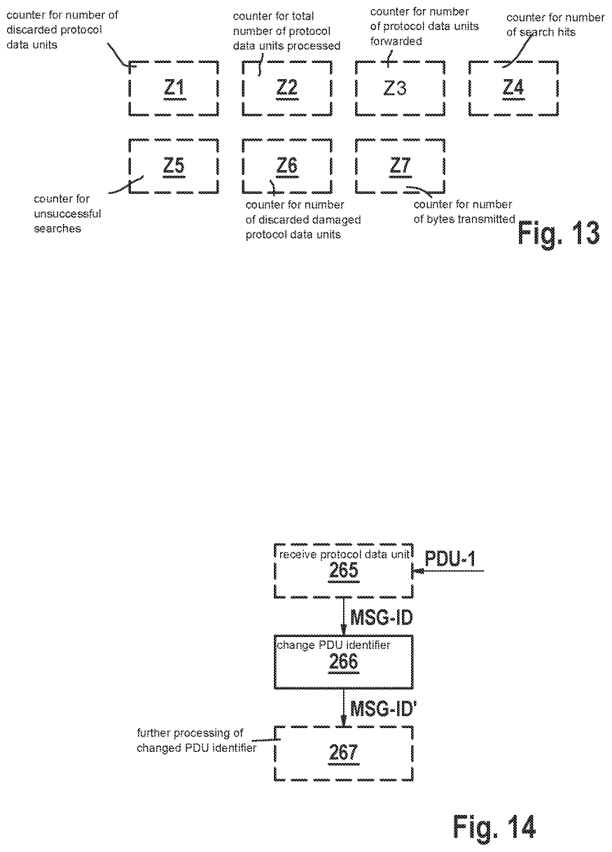

In further exemplary embodiments, it is provided that the device 100a has a conditioning apparatus E4, which is designed to change, for example normalize, a PDU identifier associated with a received protocol data unit. FIG. 14 schematically shows a simplified flow diagram according to further exemplary embodiments, wherein block 265 symbolizes an optional reception of a protocol data unit PDU-1, wherein block 266 symbolizes the change of a PDU identifier MSG-ID associated with a received protocol data unit, wherein, for example, a changed PDU identifier MSG-ID′ is obtained. The optional block 267 symbolizes a further processing of the changed PDU identifier MSG-ID′ according to further exemplary embodiments, for example a performance of a search in the first search tree B-1, E2 based on the changed PDU identifier MSG-ID′.

In further exemplary embodiments, the conditioning apparatus E4 is designed to form a search vector a2, which can be transmitted to the search apparatus E1, for example.

In further exemplary embodiments, the search vector a2 can have at least one of the following elements: a) a PDU identifier MSG-ID associated with the received protocol data unit PDU-1, b) information rxbus characterizing a, for example virtual, input interface that corresponds to, for example, a virtual device identifier of a virtual device via which the protocol data unit PDU-1 has been received, c) information rembus characterizing, for example, for at least one type of received protocol data unit PDU-1, for example for an L-PDU type, a remote receive bus of the L-PDU.

In further exemplary embodiments, the search vector a2, also referred to as “searchVector,” can also have, for example, the three aforementioned elements a), b), c): searchVector={rxbus, rembus, msgid}, wherein msgid characterizes the PDU identifier MSG-ID.

In further exemplary embodiments, the search apparatus E1 is designed to compare the search vector a2 with reference vectors of the first table E2, wherein, for example, the reference vectors define a format or one of a plurality of possible formats.

In further exemplary embodiments, one or more of the following formats can be used for the PDU identifier MSG-ID, for example based on a respective input interface 110, via which a protocol data unit PDU-1 has been received: a) for example, protocol data units associated with a CAN (controller area network) protocol or CAN bus, for example of type I-PDU (interaction layer protocol data unit, for example according to AUTOSAR), b) 11-bit standard ID, c) 29-bit extended ID, d) 32-bit message ID, for example of a CAN-XL acceptance field, e) I-PDUs associated with a LIN (local interconnect network) bus, f) AUTOSAR dynamic I-PDU multiplexing using UDP or CAN as transport layer (ASAR sockets in TUNETH DEV or CAN sockets in TUNCAN DEV), g) SomeIP S-PDU multiplexing (SomeIP socket in TUNETH DEV or CAN sockets in TUNCAN DEV), h) AVTP P1722 L-PDU multiplexing (AVB socket in TUNETH DEV).

In further exemplary embodiments, the conditioning apparatus E4 is designed to form a search vector a2, for example a compatible search vector, for example by normalizing the aforementioned formats for the PDU identifier MSG-ID, wherein, for example, a normalized search vector a2′ is obtained. For example, the search vector a2 and/or the normalized search vector a2 can have 32 bits.

In further exemplary embodiments, a function of the conditioning apparatus E4 can be characterized, for example, by the following pseudocode (“pseudocode 1”).

```
******** Pseudocode 1 - START ********
-- copy receive bus into search vector
searchVector.rxbus = tlv.rxbus
-- CAN I-PDU input
If tlv.messageType == CLF_TLV_CAN_DATA then
  searchVector.rembus = 0
  noSearch = false
  validMsg=true
  If tlv.word64[4].XDAT == 1 then
    -- CAN-XL
    searchVector.msgid = tlv.word64{5] & 0xFFFFFFFF00000000
  else
    -- standard CAN and CAN-FD If tlv.word64[4].EXT == 1
    then SearchVector.msgid = tlv.word64[4] &
    0x000000003FFF0000
  else
    SearchVector.msgid = tlv.word64[4] & 0x000000001FFFFFFF
  end
end
-- LIN I-PDU input
elseif tlv.messageType == CLF_TLV_LIN_DATA then
  searchVector.rembus = 0
  searchVector.msgid = tlv.word64[4] & 0x3F
  noSearch = false
-- AUTOSAR I-PDU multiplex input with LONG ID or
-- SomeIP S-PDU multiplex input with LONG ID
elseif tlv.messageType == CLF_TLV_PDU_LONG then
  searchVector.rembus = 0
  searchVector.msgid = tlv.word64[5] & 0x00000000FFFFFFFF
  noSearch = false
-- AUTOSAR I-PDU multiplex input with SHORT ID
elseif tlv.messageType == CLF_TLV_PDU_SHORT then
  searchVector.rembus = 0
  searchVector.msgid = tlv.word64[5] & 0x0000000000FFFFFF
  noSearch = false
-- AVBTP L-PDU multiplex input with CAN ID
elseif tlv.messageType == CLF_TLV_P1722_CAN then
  searchVector.rembus = tlv.rembus
  searchVector.msgid = tlv.word64[4] & 0x000000001FFFFFFF
  noSearch = false
-- AVBTP L-PDU multiplex input with CAN ID
elseif tlv.messageType == CLF_TLV_P1722_CAN_BRIEF then
  searchVector.rembus = tlv.rembus
  searchVector.msgid = tlv.word64[4] & 0x000000001FFFFFFF
  noSearch = false
-- AVBTP L-PDU multiplex input with LIN ID
elseif tlv.messageType == CLF_TLV_P1722_LIN then
  searchVector.rembus = tlv.rembus
  searchVector.msgid = tlv.word64[4] & 0x3F
  noSearch = false
-- AVBTP General Purpose control message
elseif tlv.messageType == CLF_TLV_P1722_GPC
  searchVector.rembus = 0
  searchVector.msgid = 0
  noSearch = true
else
  skipCount = skipCount + 1
  noSearch = true
  validMsg=true
end
******** Pseudocode 1 - END ********
```

In further exemplary embodiments, the “noSearch” variable provided in the above pseudocode 1 can be used to characterize whether or not a search is to be performed by the search apparatus E1. The information associated with the noSearch variable can be transmitted to the search apparatus E1 by the conditioning apparatus E4 in further exemplary embodiments; see, for example, arrow a3 according to FIG. 12.

In further exemplary embodiments, the “validMsg” variable provided in the above pseudocode 1 can be used to be able to distinguish between valid and invalid messages or data frames.

In further exemplary embodiments, the query “--AVBTP General Purpose control message elseif tlv.messageType==CLF_TLV_P1722_GPC” contained in the above pseudocode 1 can be used to ensure that no search is performed for a PDU identifier with the format/type AVBTP or CLF_TLV_P1722_GPC. For example, in further exemplary embodiments for such types of PDU identifiers, a configurable connection identifier VB-ID-CFG (see, for example, block 226 according to FIG. 6) can be predetermined, for example without a preceding search.

In further exemplary embodiments, it can be provided that a or the configurable connection identifier VB-ID-CFG is used for such PDU identifiers for which no search is performed.

In further exemplary embodiments, it is provided that the device 100a has an apparatus E7 for modifying header data, which apparatus is designed, for example, to selectively discard a protocol data unit PDU-1, for example based on a control a4 by the search apparatus E1, for example if the search by the search apparatus E1 has not produced a result.

In further exemplary embodiments, the device 100a has a third buffer memory E8, which can at least temporarily buffer protocol data units to be output and can, optionally, at least temporarily perform a segmentation.

In further exemplary embodiments, the device 100a has a statistics apparatus E9, which is designed to ascertain or manage statistical information with respect to an operation of the device 100, 100a or of the search apparatus E1.

In further exemplary embodiments, the device 100a, for example the statistics apparatus E9, is designed to manage at least one of the following counters mentioned by way of example, FIG. 13, a) counter Z1 for a number of discarded protocol data units, b) counter 22 for a total number of protocol data units processed by the device 100, 100a, c) counter Z3 for a number of protocol data units forwarded by means of the device 100, 100a, d) counter 24 for a number of search hits of the search apparatus E1, e) counter 25 for a number of unsuccessful searches by means of the search apparatus E1, f) counter 26 for protocol data units to be discarded, which are for example damaged, for which, for example, the conditioning apparatus E4 indicates that they are to be discarded, for example with the exception of protocol data units of the type AVB P1722 GPC, g) counter 27 for a number of bytes that have been transmitted by the device 100, 100a.

In further exemplary embodiments, at least one of the aforementioned counters Z1, 22, . . . , 27 has a data width of 32 bits, which in further exemplary embodiments enables, for example, comparatively low-frequency polling (for example, every second or less often than once per second), for example by means of software, for example by means of the software component 134 (FIG. 1).

In further exemplary embodiments, a design of the search apparatus E1 (FIG. 12) can depend on a search algorithm used. In further exemplary embodiments, the following exemplary embodiments for the search algorithm are possible, wherein both of the following exemplary embodiments are variants of, for example, a binary search and use, for example, a work table E2 (FIG. 12) and a shadow table E3.

In further exemplary embodiments, the work table E2 is used, for example, by the hardware component 132 (FIG. 1), for example for performing 200 the search (FIG. 3) and/or for ascertaining 202 a connection identifier VB-ID-1 associated with the received protocol data unit PDU-1.

In further exemplary embodiments, the shadow table E3 is used, for example, by the software component 134, for example to change the lookup table, for example if entries are added and/or removed, for example during a runtime of the device 100, 100a.

In further exemplary embodiments, for example, a binary sorted table can be used, which has, for example, a sorted plurality (“array”) of reference vectors, for example the aforementioned reference vectors. In further exemplary embodiments, for example, each entry of the binary sorted table can be designated as a node.

In further exemplary embodiments, for example, a search tree, for example a balanced search tree, for example a red-black tree, can be used; see, for example, the above description of the first search tree B-1 and the second search tree B-2. In further exemplary embodiments, for example, at least one of the search trees B-1, B-2 can be organized in the form of a table.

In further exemplary embodiments, a node structure for the at least one search tree B-1, B-2 can, for example, be characterized according to:

```
node = {
  refVector = {
    rxbus (8 bit)
    rembus (8 bit)
    msgid (32 bit)
  }
  attrib = {
    tlv = {
      pduCid (log2(entries) bit)
      canpad (4 bit)
      color(1 bit)
      modcmd (2 bit)
      modparam (11 bit) }
  sec = { secGen (1 bit) secChk (1 bit) }
  fw (1 bit)
  nodeLeft (log2(entries) bit)
  nodeRight (log2(entries) bit)
  },
```

wherein refVector characterizes a reference vector, wherein the reference vector can, by way of example, have the elements rxbus (with, for example, 8 bits), rembus (with, for example, 8 bits), msgid (with, for example, 32 bits) already described above,
wherein attrib characterizes optional attributes for a node,
wherein sec characterizes attributes associated with a possible authentication,
wherein fw characterizes an optional attribute that indicates whether a security check, for example an optional security check, for example by means of a firewall, is to be performed for a protocol data unit concerned or for protocol data units associated with a connection identifier pduCid,
wherein nodeLeft characterizes the left child node in the binary search tree,
wherein nodeRight characterizes the right child node in the binary search tree, and
wherein color characterizes a color attribute for the search tree.

In further exemplary embodiments, for example, a binary search tree, for example a binary search tree that can be stored or is stored in a hardware memory, can have the component “color.” This can be used in further exemplary embodiments to be able to modify the search tree, for example on an “in-memory” basis (i.e., directly in the memory), for example without having to create a copy, for example an expensive copy, in the working memory of the software.

In further exemplary embodiments, the search tree that can be evaluated by the hardware component 132, for example the first search tree B-1, has no color information (red-black) for its nodes. In further exemplary embodiments, this color information (red-black) is provided and/or used, for example, if nodes are added and/or removed, which operations are performed, for example, on the second search tree B-2, for example by means of the software component 134. In further exemplary embodiments, for example, the color information (red-black) associated with the nodes of the second search tree B-2 can thus be kept or at least temporarily stored in a table that can be managed by means of the software component 134.

In further exemplary embodiments, the search tree that can be evaluated by means of the hardware component 132, for example the first search tree B-1, has color information (for example, red-black) for its nodes, for example nodes realizable by means of the aforementioned “color” component.

The above embodiments mentioned by way of example based on a binary search advantageously require a search effort that is comparatively small, since it is logarithmic, based on the total number of elements of the search tree or table concerned.

In further exemplary embodiments, it is provided that, in the event of a successful search 200 (FIG. 3), the search apparatus E1 transmits the optional attributes attrib for the node found in the search 200, for example of the search tree B-1, to the apparatus E7 for modification of header data, see arrow a5 according to FIG. 12. In this case, for example, no discarding of the protocol data unit PDU-1 concerned is signaled, see arrow a4 already described above with reference to FIG. 12.

In further exemplary embodiments, it is provided that the search apparatus E1 performs at least one of the following actions in the event of an unsuccessful search 200: a) instructing the apparatus E7, for example by means of arrow a4, to discard the protocol data unit PDU-1 (wherein, for example, the counter 26, FIG. 13, can also be incremented), b) inserting a, for example static and/or configurable, connection identifier VB-ID-CFG (and/or setting a firewall flag fw, which indicates that the protocol data unit PDU-1 is to be subjected to a security check, for example by an optional firewall apparatus, for example a firewall apparatus that can be integrated into the device 100, 100a).

Further exemplary embodiments, FIG. 3, relate to a method, for example a computer-implemented method, for processing data units, for example protocol data units, for a device 100, 100a (FIGS. 1, 12), for example according to the embodiments, having a first number of input interfaces 110 for receiving protocol data units and a second number of output interfaces 120 for outputting protocol data units, and a processing apparatus 130, wherein the method comprises: performing 200 (FIG. 3), based on a PDU identifier MSG-ID associated with a received protocol data unit PDU-1, a search in at least a first search tree B-1, which has an allocation Z of in each case one PDU identifier to a connection identifier characterizing at least one data connection.

In further exemplary embodiments, it is provided that the method comprises: ascertaining 202, based on the received protocol data unit PDU-1, a connection identifier VB-ID-1 associated with the received protocol data unit PDU-1.

In further exemplary embodiments, it is provided that the processing apparatus 130 has at least one hardware component 132, wherein performing 200 the search in the first search tree B-1 and/or ascertaining 202 the connection identifier VB-ID-1 associated with the received protocol data unit is performed by means of the at least one hardware component 132.

In further exemplary embodiments, it is provided that the processing apparatus 130 has at least one software component 134, wherein the method comprises: a) at least temporarily forming 210 the search tree B-1 by means of the at least one software component 134, and/or b) at least temporarily modifying 212, for example balancing, the search tree B-1 by means of the at least one software component 134.

Further exemplary embodiments relate to a device for performing the method according to the embodiments. In further exemplary embodiments, the device can, for example, have at least one of the configurations 100, 100a already described above by way of example, with reference to FIGS. 1, 12.

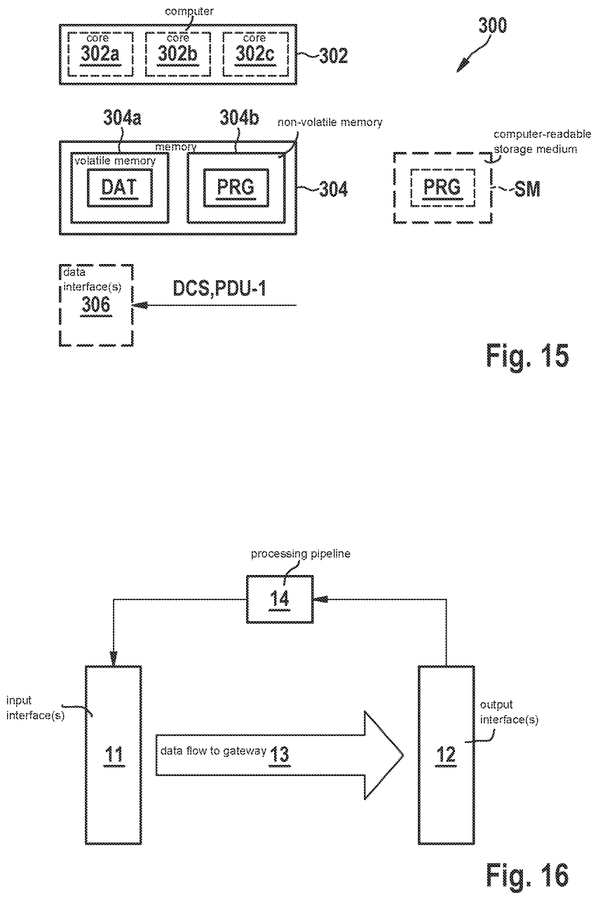

In further exemplary embodiments, the device can alternatively or additionally also have the configuration 300 shown as an example in FIG. 15 or a configuration similar thereto.

The device 300 has: a computing apparatus (“computer”) 302 having at least one computing core 302a, 302b, 302c, a memory apparatus 304, associated with the computing apparatus 302, for at least temporarily storing at least one of the following elements: a) data DAT, b) computer program PRG, in particular for performing the method according to the embodiments.

In further exemplary embodiments, the memory apparatus 304 has a volatile memory (for example, working memory (RAM)) 304a, and/or a non-volatile memory (for example, flash EEPROM) 304b, or a combination thereof or with other types of memory not explicitly mentioned.

In further exemplary embodiments, the data DAT can at least temporarily have at least one received protocol data unit PDU-1 and/or at least a portion of at least one search tree B-1, B-2, and/or associated information, for example color information characterizing red-black attributes of the second search tree B-2.

In further exemplary embodiments, at least one of the buffer memories E5, E6, E8 according to FIG. 12 can be realized, for example, by means of the memory apparatus 304 or the RAM 304a.

In further exemplary embodiments, the device 300 has at least one data interface 306 for receiving and/or transmitting data, for example protocol data units. In further exemplary embodiments, at least some of the input interfaces 110 (FIG. 1) and/or of the output interfaces 120 can be realized by means of the data interface 306, for example.

Further exemplary embodiments relate to a computer-readable storage medium SM comprising instructions that, when executed by a computer 302, cause the latter to perform the method according to the embodiments.

Further preferred embodiments relate to a computer program PRG comprising instructions that, when the program PRG is executed by a computer 302, cause the latter to perform the method according to the embodiments.

Further exemplary embodiments relate to a data carrier signal DCS that characterizes and/or transmits the computer program PRG according to the embodiments. For example, the data carrier signal DCS can be transmitted via the data interface 306 of the device 300.

In further exemplary embodiments, the device 100, 100a, 300 can be used, for example, for or in an automotive gateway, i.e., a gateway for applications in the field of automotive engineering, wherein, for example, for incoming protocol data units PDU-1 at the device, a respective connection identifier VB-ID-1 can be ascertained, for example by means of hardware, and wherein, for example, based on the ascertained connection identifier VB-ID-1, the incoming protocol data units PDU-1 can be output.

In further exemplary embodiments, the input interfaces 110 and/or the output interfaces 120 can, for example, in each case also have at least one virtual interface, for example in contrast to a physical interface.

In further exemplary embodiments, a virtual interface can be characterized in that individual data units, for example protocol data units, for example as a so-called “contained PDU,” are present, for example, in an Ethernet or UDP packet, for example a so-called “container PDU.” In further exemplary embodiments, the contained PDUs can be extracted from the container PDU, for example by means of a packet parser.

In further exemplary embodiments, a common data format or message format, for example for processing incoming protocol data units PDU-1, can be used by the device according to the embodiments, for example independently of a respective type (for example, L-PDUs, I-PDUs, N-PDUs, S-PDUs) of the incoming protocol data units PDU-1.

In further exemplary embodiments, the received protocol data units PDU-1, for example based on the search 200 (FIG. 3) or the ascertaining 202, are provided with a connection identifier VB-ID-1, which is, for example, independent of the protocol or of a respective type (for example, L-PDUs, I-PDUs, N-PDUs, S-PDUs) of the incoming protocol data units PDU-1 and on the basis of which, for example, routing, for example forwarding, of the protocol data units PDU-1 can be performed by the device or in the device, for example to one or more (multicast) output interfaces.

In further exemplary embodiments, a modification of the PDU identifier PDU-ID can be selectively performed.

In further exemplary embodiments, unknown protocol data units (for which the search 200 or the ascertaining 202 was negative, for example, and thus did not lead to a connection identifier associated with the PDU identifier PDU ID) can be processed further, for example by means of the software component 134, for example by a computer program that can be provided for this purpose and performs, for example, a detailed analysis of the unknown protocol data unit or a security analysis.

In further exemplary embodiments, the device 100, 100a, 300 according to the embodiments can be used, for example, as a, for example unidirectional, feedback apparatus for a gateway, for example for an automotive gateway 10, see FIG. 16, wherein, for example, the device 100, 100a, 300 is designed to receive protocol data units PDU-1 from at least one output interface 12 of the gateway 10 and to supply the protocol data units PDU-1 to at least one input interface 11 of the gateway 10. For example, block 14 in FIG. 16 can have the configuration 100, 100a, 300 according to the embodiments described above by way of example. Block arrow 13 symbolizes a data flow in the gateway 10, for example from the input interface 11 to the output interface 12, such as is associated with a processing pipeline of the gateway 10, for example.

In further exemplary embodiments, the device 100, 100a, 300 is designed to receive data units, for example complete data units, for example protocol data units, for example sequentially in time (“serialized”), for example from a component of the at least one output interface 12 of the gateway 10.

In further exemplary embodiments, the device 100, 100a, 300 is designed to output protocol data units to be output, in the same format as they have been received. In further exemplary embodiments, the device 100, 100a, 300 is designed to insert a connection identifier ascertained, for example, based on the search 200, into a received protocol data unit PDU-1.

In further exemplary embodiments, the device 100, 100a, 300 is designed to change a type, for example a message type, of a received protocol data unit PDU-1.

In further exemplary embodiments, the device 100, 100a, 300 is designed to change, for example correct, a length of a received protocol data unit PDU-1, for example in the case of received padded data units associated with CAN-FD data frames, for example. In further exemplary embodiments, this can be useful, for example, if the received protocol data unit PDU-1 is to be forwarded to another output interface (for example of the CAN-FD type), for example with its actual length (and not, for example, the length caused by the padding).

In further exemplary embodiments, the device 100, 100a, 300 is designed to load a table associated with the at least one search tree B-1, B-2 or characterizing the at least one search tree B-1, B-2, for example to load it dynamically, i.e., during an operation of the device, wherein the loaded data DAT can be stored, for example at least temporarily, in the memory apparatus 304. In further exemplary embodiments, for example, the second search tree B-2 can thus be loaded into the device, for example externally, and at a predeterminable point in time, for example when the device is reset, the content of the second search tree B-2 can be transmitted to the first search tree B-1 so that, from then on, the first search tree B-1 can be used with the new content based on the loaded second search tree B-2, for example for the hardware-based search 200.

In further exemplary embodiments, the device 100, 100a, 300 can selectively use, for example, a search tree B-1 or a first search tree B-1 and a second search tree B-2 or corresponding tables, wherein, for example, in some exemplary embodiments, a memory region available for the search tree (s) or the corresponding tables can be used for a search tree B-1 or a table, wherein, for example, in further exemplary embodiments, the memory region available for the search tree (s) or the corresponding tables can be used for both search trees B-1, B-2 or corresponding tables so that, for example, in the case of two search trees, approximately half the storage capacity results for in each case one search tree, compared to the case of a single search tree B-1.

In further exemplary embodiments, the first buffer memory E5 can be used, for example, for a rate adaptation, i.e., for example, for an adaptation of a rate at which received protocol data units PDU-1 are output via at least one output interface 120a of the second number of output interfaces 120. In further exemplary embodiments, the rate can be controlled 261 or regulated 262, for example (FIG. 11).

In further exemplary embodiments, both a rate at which protocol data units are received from the gateway 10 or its output interface 12 and a rate at which protocol data units are transmitted to the gateway 10 or its input interface 12 can be predetermined, for example, by the processing pipeline 14.

In further exemplary embodiments, the device 100, 100a, 300 is designed to receive incoming protocol data units, for example in the form of “bursts,” i.e., intermittently.

In further exemplary embodiments, the search apparatus E1 is designed to operate at a non-constant rate with respect to a processing (for example, search) because, for example, individual searches 200 for different received protocol data units, for example in the first search tree B-1, can take different amounts of time, for example.

In further exemplary embodiments, an optionally or selectively activatable security check for individual protocol data units, for example by a firewall apparatus (not shown), can also lead to a non-constant processing rate for protocol data units.

In further exemplary embodiments, such a possibly non-constant processing rate can be at least partially compensated or adjusted to a predeterminable rate, for example by using at least one of the buffer memories E5, E6, E8.

In further exemplary embodiments, the first buffer memory E5 is designed to output status information a6, for example to a component 12 of the gateway 10 providing the protocol data units PDU-1, which indicates, for example, that a first fill level of the first buffer memory E5, for example a configurable fill level, has been reached. In further exemplary embodiments, the first buffer memory E5 is designed to no longer output the status information a6, for example if the, for example configurable, first fill level (or a predeterminable second fill level, which can be different from the first fill level, for example for achieving a hysteresis) of the first buffer memory E5 is undershot again.

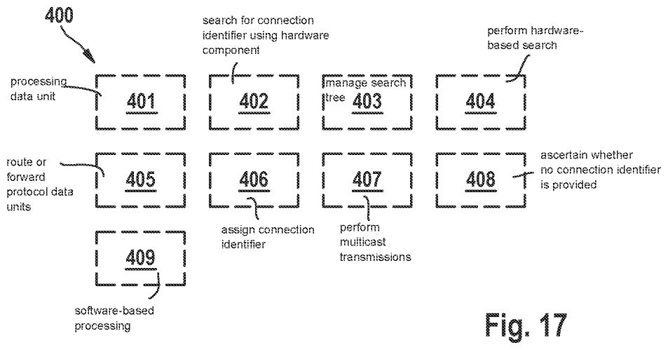

Further exemplary embodiments, FIG. 17, relate to a use 400 of the device 100, 100a, 300 according to the embodiments and/or of the method according to the embodiments and/or of the computer-readable storage medium SM according to the embodiments and/or of the computer program PRG according to the embodiments and/or of the data carrier signal DCS according to the embodiments and/or of the gateway 10 according to the embodiments for at least one of the following elements: a) processing 401 data units, for example protocol data units PDU-1, for example of a vehicle, for example a motor vehicle, b) ascertaining 402, for example searching for, for example by means of a hardware component 132, a connection identifier associated with a received protocol data unit PDU-1, c) managing 403 at least one search tree B-1, B-2, d) performing 404 a hardware-based search of a connection identifier for a data unit, for example a protocol data unit, for example of a gateway 10 for automotive applications, wherein, for example, the search can be performed with logarithmic effort, e) routing 405 or forwarding data units, for example protocol data units, for example of a vehicle, for example a motor vehicle, wherein, for example, the data units can be of different types, f) assigning 406 a connection identifier, for example a connection identifier independent of the protocol, g) performing 407 multicast transmissions, h) ascertaining 408 whether no connection identifier is provided, for example stored, for example contained in the search tree B-1, for a predeterminable received data unit, for example a protocol data unit, i) software-based processing 409 of a received data unit, for example a protocol data unit, for which no connection identifier is provided, for example stored, for example contained in the search tree.

1-27. (canceled)

28. A device for processing data units including protocol data units, comprising:
a first number of input interfaces configured to receive protocol data units;
a second number of output interfaces configured to output protocol data units; and
a processing apparatus configured to search, based on a PDU identifier associated with a received protocol data unit, a search in at least a first search tree, which has an allocation of in each case one PDU identifier to a connection identifier characterizing at least one data connection.

29. The device according to claim 28, wherein the device is configured to ascertain, based on the received protocol data unit, a connection identifier associated with the received protocol data unit.

30. The device according to claim 29, wherein the processing apparatus has at least one hardware component, which is configured to perform the search in the first search tree and/or to ascertain the connection identifier associated with the received protocol data unit.

31. The device according to claim 28, wherein the first search tree is a binary tree.

32. The device according to claim 29, wherein the device is configured to output, based on the connection identifier associated with the received protocol data unit, the received protocol data unit to at least one particular output interface of the second number of output interfaces.

33. The device according to claim 30, wherein the processing apparatus has at least one software component which is configured to at least temporarily a) form the first search tree and/or b) modify the first search tree.

34. The device according to claim 33, wherein the at least one software component is configured to perform a predeterminable response when no connection identifier associated with the received protocol data unit can be ascertained for the received protocol data unit, wherein the predeterminable response has at least one of the following elements: a) discarding the received protocol data unit, b) assigning a connection identifier to the received protocol data unit, c) setting or inserting a first piece of information for the received protocol data unit, wherein the first piece of information indicates that the received protocol data unit is to be subjected to a check using a firewall apparatus.

35. The device according to claim 33, wherein the at least one software component is configured to: (i) generate, based on the first search tree, a second search tree, and/or (ii) to modify the second search tree.

36. The device according to claim 35, wherein: a) the first search tree and/or the second search tree is a red-black tree, and/or b) the device is configured to organize the first search tree and/or the second search tree at least temporarily in the form of at least one table.

37. The device according to claim 35, wherein the device is configured to, in a manner at least partially overlapping in time, a) ascertain, based on the received protocol data unit, a connection identifier associated with the received protocol data unit using the at least one hardware component by performing the search in the first search tree using the at least one hardware component, and b) generate, using the at least one software component the second search tree based on the first search tree, and/or modify the second search tree.

38. The device according to claim 35, wherein the device is configured to perform at least one of the following elements: a) using the first search tree or the second search tree selectively to ascertain the connection identifier associated with the received protocol data unit), b) transmitting a content of the second search tree and/or a structure of the second search tree to the first search tree, c) transmitting a content of the first search tree and/or a structure of the first search tree, to the second search tree.

39. The device according to claim 35, wherein the at least one software component is configured to signal to the at least one hardware component, at least one of the following elements using a a second piece of information: a) the first search tree is to be used for performing the search, b) the second search tree is to be used for performing the search, c) a modification of the first search tree and/or of the second search tree including an insertion of at least one node and/or a balancing of the first search tree and/or of the second search tree, has been completed.

40. The device according to claim 39, wherein the at least one hardware component is configured to use, based on the signaling, the first search tree or the second search tree for performing the search.

41. The device according to claim 40, wherein the at least one hardware component is configured to activate the first search tree or the second search tree for performing a search between two successive searches for a future performance of the search or searches, by specifying which of the first search tree and the second search tree is to be used from then on for performing the search or searches.

42. The device according to claim 28, wherein the device is configured to control or regulate a rate at which protocol data units are output via at least one output interface of the second number of output interfaces.

43. The device according to claim 28, further comprising at least one memory for at least temporarily storing one or more protocol data units or parts of one or more protocol data units.

44. The device according to claim 28, further comprising a conditioning apparatus, which is configured to change a PDU identifier associated with a received protocol data unit.

45. A computer-implemented method for processing data units for a device having a first number of input interfaces configured for receiving protocol data units and a second number of output interfaces configured for outputting protocol data units, and a processing apparatus, the method comprising:
performing, based on a PDU identifier associated with a received protocol data unit, a search in at least a first search tree, which has an allocation of in each case one PDU identifier to a connection identifier characterizing at least one data connection.

46. The method according to claim 45, further comprising:
ascertaining, based on the received protocol data unit, a connection identifier associated with the received protocol data unit.

47. The method according to claim 46, wherein the processing apparatus has at least one hardware component, wherein the performing of the search in the first search tree and/or the ascertaining of the connection identifier associated with the received protocol data unit is performed using the at least one hardware component.

48. The method according to claim 45, wherein the processing apparatus has at least one software component, and wherein the method further comprises:
a) at least temporarily forming the first search tree using the at least one software component, and/or
b) at least temporarily balancing the first search tree using the at least one software component.

49. A device configured for processing data units for a device having a first number of input interfaces configured for receiving protocol data units and a second number of output interfaces configured for outputting protocol data units, and a processing apparatus, the device configured to:
perform, based on a PDU identifier associated with a received protocol data unit, a search in at least a first search tree, which has an allocation of in each case one PDU identifier to a connection identifier characterizing at least one data connection.

50. A non-transitory computer-readable storage medium on which is stored instructions for processing data units for a device having a first number of input interfaces configured for receiving protocol data units and a second number of output interfaces configured for outputting protocol data units, and a processing apparatus, the instructions, when executed by a computer, causing the computer to perform:
performing, based on a PDU identifier associated with a received protocol data unit, a search in at least a first search tree, which has an allocation of in each case one PDU identifier to a connection identifier characterizing at least one data connection.

51. An automotive gateway, comprising:
at least one device for processing data units including protocol data units, including:
a first number of input interfaces configured to receive protocol data units;
a second number of output interfaces configured to output protocol data units; and
a processing apparatus configured to search, based on a PDU identifier associated with a received protocol data unit, a search in at least a first search tree, which has an allocation of in each case one PDU identifier to a connection identifier characterizing at least one data connection.

52. The device according to claim 28, wherein the device is used for at least one of the following elements:
a) processing protocol data units of a motor vehicle,
b) searching for, using a hardware component, a connection identifier associated with a received protocol data unit,
c) managing at least one search tree,
d) performing a hardware-based search of a connection identifier of a gateway for a protocol data unit for an automotive application,
e) routing or forwarding protocol data units of a motor vehicle, wherein, the protocol data units can be of different types,
f) assigning a connection identifier independent of a protocol,
g) performing multicast transmissions,
h) ascertaining whether no connection identifier is provided for a predeterminable received protocol data unit,
i) software-based processing of a received protocol data unit for which no connection identifier is provided.
